(19) United States
(12) Patent Application Publication
(10) Pub. No.: US 2008/0305267 A1
(43) Pub. Date: Dec. 11, 2008

(54) Method and apparatus for low cost high rate deposition tooling

(76) Inventors: H. Robert Gray, Sebastopol, CA (US); Norman L. Boiling, Santa Rosa, CA (US)

Correspondence Address: D. Joseph English, Suite 1000, 505 9th Street, N.W., Washington, DC, 20004, US

(21) Appl. No.: 12/155,544

(22) Filed: Jun. 5, 2008

Related U.S. Application Data
(60) Provisional application No. 60/924,930, filed on Jun. 5, 2007.

(51) Int. Cl. B05D 3/12; B05C 13/00

(52) U.S. Cl. 427/346; 118/56

(57) ABSTRACT

An apparatus and method for depositing material on an array of substrates. The array of substrates may be moved past one or more sources of deposition material in a first rotational motion. The array of substrates may also be concurrently moved in a second rotational motion. The combination of the first and second rotational motions cause each of the substrates to move about its longitudinal axis without gears and bearings.

### RELATED APPLICATIONS

The instant application is co-pending with and claims the priority benefit of Provisional Application No. 60/924,930, filed Jun. 5, 2007, entitled “Low Cost High Rate Deposition Tooling,” by the same inventors, the entirety of which is incorporated herein by reference.

### BACKGROUND

Embodiments of the present subject matter generally relate to the deposition of thin films on substrates where complex rotational tooling is required to achieve a uniformity in coating. Tungsten-halogen incandescent lamps and drill bits are two examples of such substrates. Prior art coating systems for such substrates generally utilize magnetron sputtering systems. FIGS. 1 and 2 are perspective views of prior art magnetron sputtering systems. With reference to FIG. 1, conventional magnetron sputtering systems utilize a cylindrical, rotatable drum 2 mounted in a vacuum chamber 1 having sputtering targets 3 located in a wall of the vacuum chamber 1. Plasma or microwave generators 4 known in the art may also be located in a wall of the vacuum chamber 1. Substrates 6 may be removably affixed to panels or substrate holders 5 on the drum 2. With reference to FIG. 2, substrates 6, such as lamps, may be attached to the rotatable drum 2 via a conventional substrate holder 8. Conventional substrate holders 8 generally includes a plurality of gears and bearings 9 allowing one or more lamps 6 to rotate about its respective axis. Material from the sputtering target 3 may thus be distributed around the lamps 6 as they pass a target 3. Obtaining sufficient uniformity in coating generally requires plural rotations past the target 3.

The prior art systems illustrated in FIGS. 1 and 2 and the respective tooling are deficient in several aspects. For example, bearings and gears are required for each lamp and a single coating run may contain several thousand lamps, making the initial construction costs high. Maintenance of such tooling is costly, both in parts and in the labor required to replace worn gears and bearings. The bearings also impose limitations on operating temperatures which limits material choices and film quality.

Another limitation of prior art systems and tooling is that the present gearing configurations cause two adjacent substrates to rotate in opposite directions. This results in two different sets of coating conditions in the chamber, one condition applying to the substrates rotating clockwise, the other condition applying to the substrates rotating counterclockwise. This deficiency in the art also forces a compromise between the two sets of coating conditions making it impossible to optimize the coating on both sets of substrates. Prior art tooling also lacks flexibility, with each set of tooling being designed specifically for a single type or size substrate to maximize load size. Different size substrates require the construction of an entirely new set of tooling thereby adding to the overall cost.

A further shortcoming of prior art tooling is the physical thickness of the substrate holders or racks. Substrates such as lamps are generally complex in shape, are difficult to uniformly coat, and are adversely affected by physical shadowing from the tooling. Accordingly, there is a need in the art for an apparatus and method for efficiently depositing a layer of material on an array of substrates.

One embodiment of the present subject matter therefore provides a novel method of depositing a layer of material on an array of substrates in which the array is moved past one or more sources of deposition material in a first angular motion while concurrently being moved in a second angular motion. Each substrate may then be moved in a third angular motion caused by the centripetal forces from the first and second angular motions.

Another embodiment of the present subject matter provides a process of depositing a layer of material on an array of substrates in which the array is moved past one or more sources of deposition material in a first angular motion while concurrently being moved in a second angular motion where the centripetal forces from the first and second angular motions cause each substrate to rotate about its respective axis.

A further embodiment of the present subject matter provides a method of depositing material on an array of substrates comprising moving the array of substrates past one or more sources of deposition material in a first rotational motion. The array of substrates may be concurrently moved in a second rotational motion, where the combination of the first and second motions cause each of the substrates to move in a third rotational motion.

An additional embodiment of the present subject matter provides a method of depositing a layer of material on an array of substrates comprising moving the substrates in a first motion past one or more sources of deposition material, where the first motion comprises rotating a carrier about its longitudinal axis. Each substrate may be concurrently rotated about its longitudinal axis without gears and bearings.

One embodiment of the present subject matter provides a method of depositing a layer of material on an array of substrates comprising moving the substrates in a first motion past one or more sources of deposition material where the first motion comprises rotating a carrier about its longitudinal axis. Each substrate may be concurrently rotated about its longitudinal axis and adjacent substrates rotate in the same direction about their respective longitudinal axes.

Yet another embodiment of the present subject matter provides a process for moving an array of substrates past one or more sources of deposition material comprising providing one or more pallets, each pallet comprising one or more axially aligned disks, each disk having a plurality of substrate holders positioned about the periphery thereof. A pallet carrier may be provided and the pallets may be positioned about the periphery of the pallet carrier. Each substrate may be positioned on a substrate holder and the carrier rotated about its central axis. The method may further include driving the pallets to rotate each disk about its central axis where the forces exerted on the substrates as a result of driving the carrier and the pallets effect rotation of each substrate about its central axis.

One embodiment of the present subject matter provides an apparatus for moving an array of substrates in a thin film deposition process. The apparatus may comprise a carrier having a generally circular cross-section and being rotatable about its central axis, and a carrier driving mechanism for rotating the carrier about its central axis. The apparatus may include a plurality of pallets, each pallet comprising a rotatable central shaft and one or more disks axially aligned along the central shaft, each disk comprising a plurality of spindle carrying wells positioned about the periphery of the disk and each well having a generally cylindrical wall. A pallet driving mechanism may be provided for rotating the central shaft of each pallet to thereby rotate each disk about its central axis, and plural spindles may be provided each having a generally cylindrical wall, each spindle being adapted to be carried by a spindle carrying well so that the generally cylindrical wall of the spindle is adjacent the generally cylindrical wall of the spindle carrying well, each spindle being adapted to carry at least one substrate in axial alignment with the axis of the generally cylindrical wall of the spindle.

A further apparatus according to an embodiment of the present subject matter comprises a carrier having a generally circular cross-section and being rotatable about its central axis and a carrier driving mechanism for rotating the carrier about its central axis. A plurality of pallets may be provided, each pallet comprising a rotatable central shaft and one or more disks axially aligned along the central shaft, each disk comprising a plurality of substrate carrying rods positioned about the periphery of the disk, each rod being adapted to carry one or more substrates. The apparatus may also include a pallet driving mechanism for rotating the central shaft of each pallet to thereby rotate each disk about its central axis.

An additional embodiment of the present subject matter provides an apparatus for carrying substrates in a thin film deposition system. The apparatus may comprise a major carrier rotatable about a central axis and one or more planetary disks carried by the major carrier and spaced from the central axis thereof, each planetary disk being rotatable about its central axis. Plural substrate holders may be positioned about the periphery of the planetary disks, each substrate holder being adapted to carry one or more substrates so that centripetal forces resulting from the rotation of the major carrier and the disks effects the rotation of each substrate carried by the disks about an axis of the substrate.

Another embodiment of the present subject matter provides a method of optimizing film distribution and oxidation of a layer of material on an array of substrates. The method comprises moving the array of substrates past one or more sources of deposition material in a first angular motion while the array is concurrently being moved in a second angular motion. The first and second angular motions are substantially equal in magnitude and have opposite directions.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIGS. 1 and 2 are perspective views of prior art magnetron sputtering systems.

FIG. 3 is a perspective view of an apparatus according to one embodiment of the present subject matter.

FIG. 4 is a perspective view of a portion of a pallet according to one embodiment of the present subject matter.

FIGS. 5 and 6 are perspective views of pallets according to additional embodiments of the present subject matter.

FIGS. 7-10 are pictorial representations of embodiments of the present subject matter.

FIG. 11 is a graphical representation of rotation rates of embodiments of the present subject matter.

FIG. 12 is a graphical representation of angular accelerations of embodiments of the present subject matter.

FIG. 13 is a graphical representation of rotation rates of embodiments of the present subject matter.

FIG. 14 is a perspective view of another embodiment of the present subject matter.

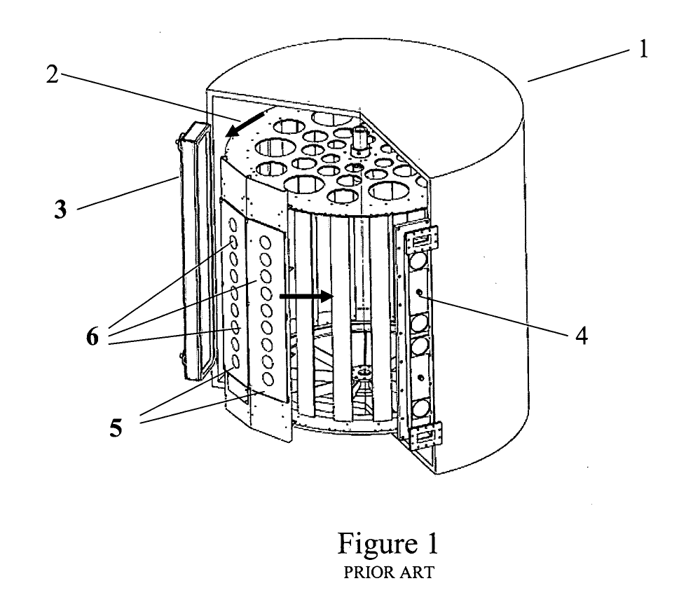

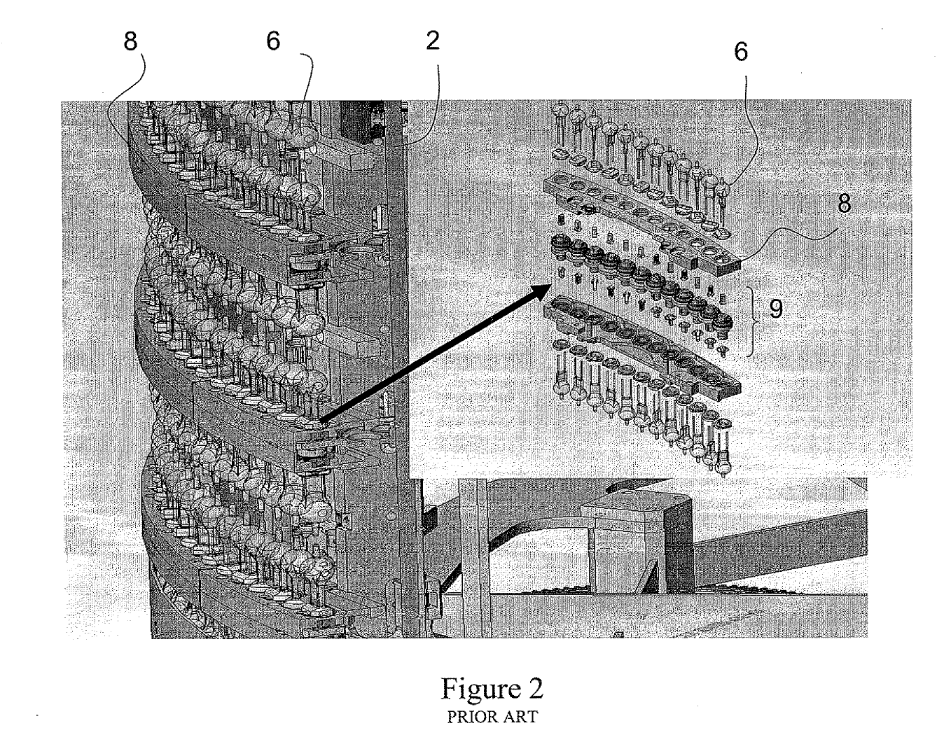

### DETAILED DESCRIPTION OF THE DRAWINGS

With reference to the figures where like elements have been given like numerical designations to facilitate an understanding of the present subject matter, the various embodiments of a method and apparatus for low cost high rate deposition tooling are herein described.

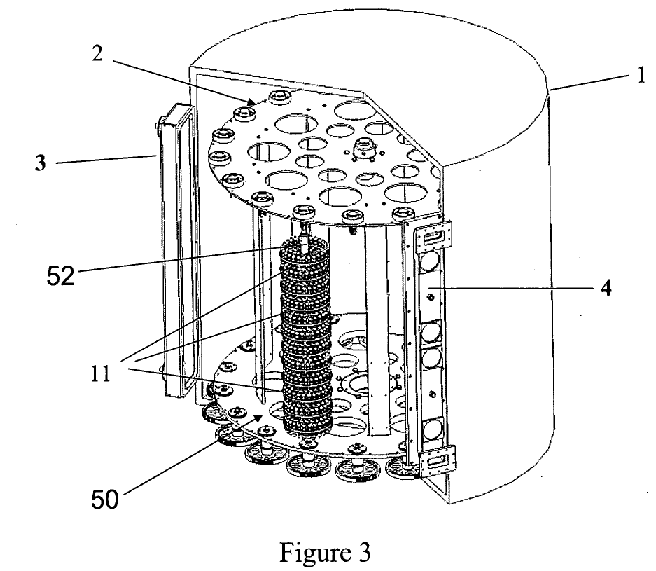

FIG. 3 is a perspective view of an apparatus according to one embodiment of the present subject matter. With reference to FIG. 3, an exemplary apparatus may utilize a substantially cylindrical, rotatable drum or carrier 2 mounted in a vacuum chamber 1 having sputtering targets 3 located in a wall of the vacuum chamber 1. Plasma or microwave generators 4 known in the art may also be located in a wall of the vacuum chamber 1. The carrier 2 may have a generally circular cross-section and is adaptable to rotate about a central axis. A driving mechanism (not shown) may be provided for rotating the carrier 2 about its central axis. A plurality of pallets 50 may be mounted on the carrier 2 in the vacuum chamber 1. Each pallet 50 may comprise a rotatable central shaft 52 and one or more disks 11 axially aligned along the central shaft 52. In one embodiment, the disk 11 may be substantially solid.

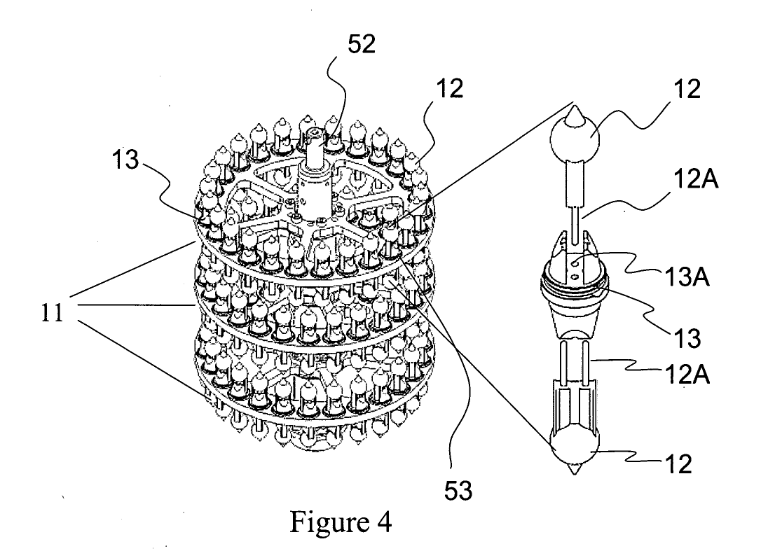

FIG. 4 is a perspective view of a portion of a pallet according to one embodiment of the present subject matter. With reference to FIG. 4, the pallet 50 may include a disk II having a plurality of arms radiating from a central axis or hub thereof, similar to spokes on a wheel. At the end of the spokes may be a peripheral ring whereby each ring, planetary disk, or annular disk 11 may comprise a plurality of spindle carrying wells 53 positioned about the periphery of the disk 11. Each well 53 may also have a generally cylindrical wall. In one embodiment, the well 53 may further include a bottom and/or may include a lip at the peripheral edges thereof. A pallet driving mechanism (not shown) may be provided for rotating the central shaft 52 of each pallet 50 to thereby rotate each disk 11 or planet about its central axis. The rotation speed of the pallet 50 may be separately controlled from the rotation speed of the carrier 2. A plurality of spindles 13 each having a generally cylindrical wall are adapted to be carried by a spindle carrying well 53 so that the generally cylindrical wall of the spindle 13 is adjacent the generally cylindrical wall of the spindle carrying well 53. In one embodiment, the generally cylindrical wall of the spindle 13 may be knurled. Each spindle 13 may carry one or more substrates 12, such as a lamp, in axial alignment with the axis of the generally cylindrical wall of the spindle 13. The substrate 12 to be coated may be mounted on the spindle 13 in any number of methods. For example, if a lamp is provided as the substrate, the lamp lead wires 12A may be inserted into holes 13A drilled into the spindle 13.

When the disks 11 are rotated about their respective axes and the carrier 2 rotated about its respective axis, the spindles 13 in the wells 53 are subjected to two centripetal forces. The sum of these two independent forces, when proper conditions are chosen, forces each spindle 13 into contact with the wall of the associated well 53. The resulting force of the wall on the spindle 13 causes the spindle 13 to roll around the well 53. The pallets 50, and hence the disks 11, may be rotated in the same or opposite direction as the carrier 2. Further, each of the spindles 13 in a pallet 50 or multiple pallets may rotate in one direction or may alternate rotation in the clockwise and counterclockwise directions.

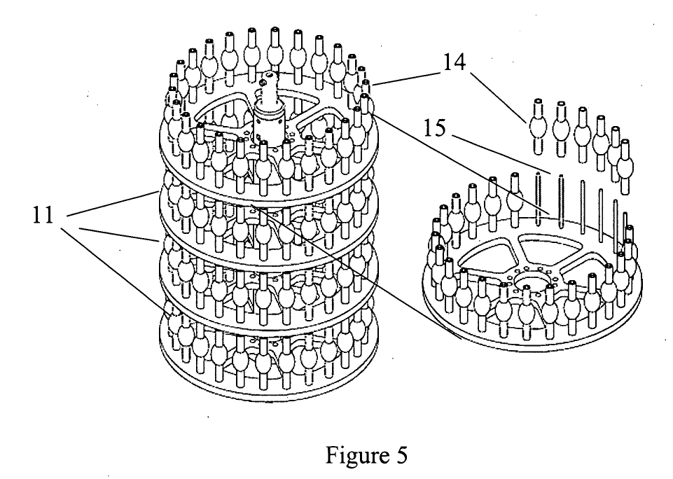

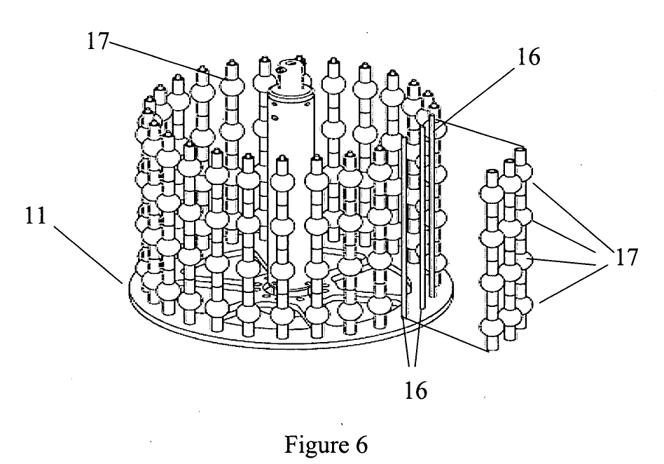

FIGS. 5 and 6 are perspective views of pallets according to embodiments of the present subject matter. With reference to FIG. 5, an alternative substrate holder arrangement may be utilized to coat open-ended substrates 14, such as arc tubes or the like. In this embodiment, each spindle carrying well may be replaced by a rod 15 positioned about the periphery of the disk 11 or planet. In embodiments for coating tubes or other open-ended substrates 14, the inner diameter of the tube 14 is greater than the diameter of the holding rod 15; therefore, the centripetal forces on the tube 14 cause it to roll around the rod 15. As in the embodiment including spindles and wells, the result is a rotation of the substrate as it passes the target without bearings or gears. With reference to FIG. 6, an alternative rod configuration 16 may be employed to coat plural tubes, lamp envelopes, or similar structures 17 on a single rod thereby allowing a larger number of such envelopes to be mounted into an exemplary apparatus, resulting in increased productivity.

Replacing the standard tooling racks with disks adds a third dimension to the drum arrangement to thereby provide a larger area to mount substrates than the cylindrical surface of a drum. A comparison between the coating rates for conventional tooling and for tooling according to embodiments of the present subject matter, using the same drum rotation rates and sputtering power for the targets, shows that the average deposition rate is decreased for the new tooling due to the material being deposited over a larger area. The effective increase in the drum diameter results in a longer time interval between successive passes in front of the target for each substrate, and the necessary oxidation of the film becomes easier to achieve. This permits an increase of power to the sputtering targets, increasing both the instantaneous deposition rate in front of the target and the average deposition rate seen by a substrate on the drum. The target power may be increased until the average deposition rate is comparable to the coating rates achieved with the old tooling, thus improving machine throughput due to the increased load size.

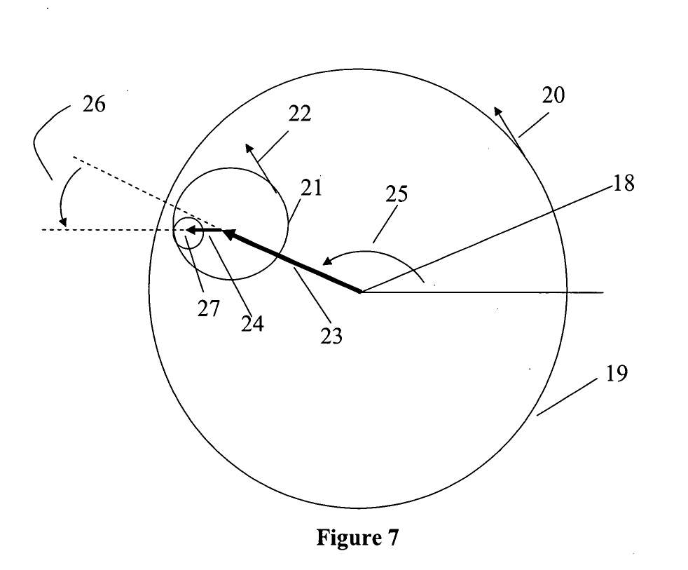

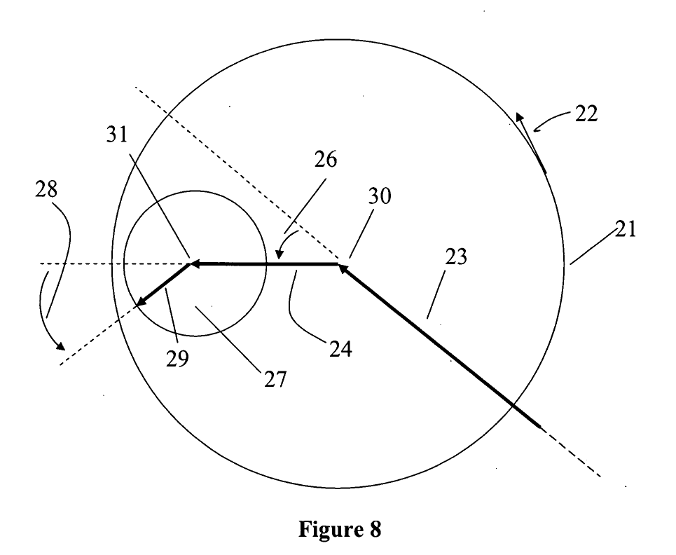

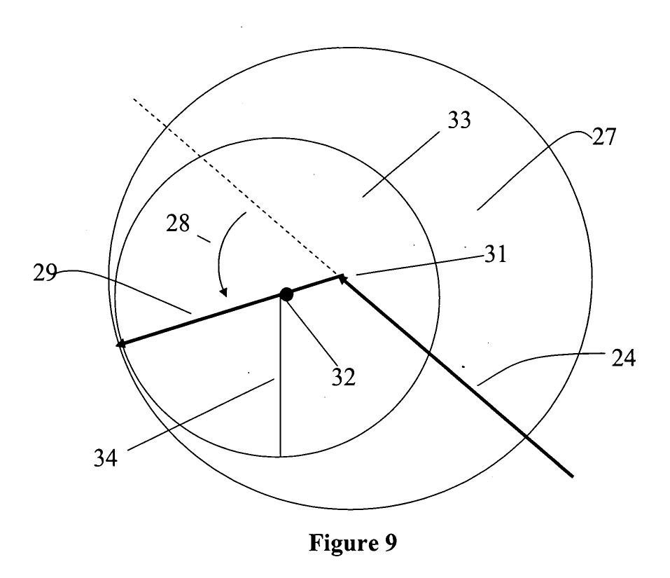

Embodiments of the present subject matter may be further understood through a mathematical analysis and a pictorial representation thereof in FIGS. 7-10. The coordinate system used herein is relative to the central axis 18 of an exemplary drum. The following definitions will be useful with regard to FIGS. 7-10 and the mathematical analysis below:

r̅₁ represents a vector 23 from the center 18 of the drum 19 to the center 30 of the planet 21 or disk.

r̅₂ represents a vector 24 from the center 30 of a the planet 21 to the center 31 of the spindle well 27.

r̅₃ represents a vector 29 from the center 31 of the spindle well 27 to a point on the well wall.

r₄ represents the radius 34 of the spindle 33 as measured from the center 32 thereof.

θ₁ represents an angle 25 through which the drum has rotated at time t.

θ₂ represents the angle 26 between r̅₁ and r̅₂. It should be noted that this is not the total angle through which the planet has moved in time t, but is rather the additional angle the planet has moved relative to θ₁.

θ₃ represents the angle 28 between r̅₂ and r̅₃. This angle is generally a function of r̅₁, r̅₂ r̅₃, ω₁, ω₂, and t. As with θ₂, this is not the total angle through which the arbitrary point has moved, but is the additional angle the point has moved relative to r̅₂.

ω₁ represents the drum rotation speed=dθ₁/dt (radian/second).

f₁ represents the direction of drum rotation 20=ω₁/2π (rotation/second).

ω₂ represents the planet rotation speed=dθ₂/dt (radian/second).

f₂ represents the direction of planet rotation 22=ω₂/2π (rotation/second).

ω₃ represents the rotation speed of the point on the wall at which the normal acceleration is maximum=dθ₃/dt (radian/second).

ω₄ represents the rate at which the spindle rotates about its own axis=dθ₄/dt (radian/second).

α_{N} represents the normal component of the acceleration of a point on the well wall.

I₄ represents the moment of inertia for the spindle.

τ_{4d} represents the driving torque exerted on the spindle by the well wall.

τ_{4f} represent the torque caused by friction between the spindle and the well floor.

μ_{fs} represents the coefficient of sliding friction between the spindle and the floor of the well.

μ_{4d} represents the coefficient of static friction between the spindle and the well wall.

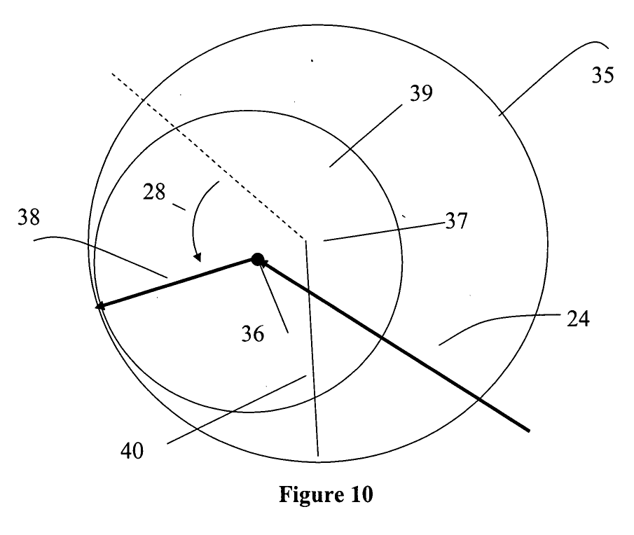

FIG. 10 pictorially illustrates the alternative embodiment of the present subject matter in FIGS. 5 and 6 where each spindle carrying well may be replaced by a rod 39 positioned about the periphery of the planet 21. In this case, r̅₃ represents a vector from the center 36 of the rod 39 to the surface of the rod. Hollow substrates such as an open ended tube 35 may be placed over the rod 39. The same equations below that predict the motion of the spindle rotating around the well wall describe the motion of a tube rotating around a rod. It should be noted, however, that in this particular case r₃ is now the vector from the center 37 of the rod to a point on its surface, r₄ is the radius 40 of the tube, and that r₄ is now larger than r₃. In this embodiment, rather than considering the motion of an arbitrary point on the well wall, the equations would describe the motion of an arbitrary point on the surface of the rod. An examination of the equations below readily shows that the smaller the radius of the rod, the faster the rotation rate of the tube.

Considering a point on an exemplary well wall designated by the position vector r̅, it may be assumed that a spindle will contact the wall at the point at which the normal component of the acceleration is maximum, and that the spindle will remain in such contact at all times. The total velocity and acceleration of this point (including both normal and tangential components) are a function of time, ω₁, ω₂, r̅₁, and r̅₂. To obtain these functions, the position vector r̅ may be written as:

r̅= r̅₁+ r̅₂+ r̅₃ (1)

Equation (1) may then be expressed as:

r̅=r₁[î cos θ₁+ĵ sin θ₁]+r₂[î cos(θ₁+θ₂)+ĵ sin(θ₁+θ₂)]+r₃[î cos(θ₁+θ₂+θ₃)+ĵ sin(θ₁+θ₂+θ₃)] (2)

The position vector r̅ may then be rewritten in terms of rotation speeds and θ₃:

$$\overline{r} = {r}_{1} ( \begin{matrix}\hat{i} cos {ω}_{1} t + \\ \hat{j} cos {ω}_{1} t\end{matrix} ) + {r}_{2} ( \begin{matrix}\hat{i} cos ( {ω}_{1} + {ω}_{2} ) t + \\ \hat{j} sin ( {ω}_{1} + {ω}_{2} ) t\end{matrix} ) + {r}_{3} ( \begin{matrix}\hat{i} cos ( {ω}_{1} t + {ω}_{2} t + {θ}_{3} ) + \\ j sin ( {ω}_{1} t + {ω}_{2} t + {θ}_{3} )\end{matrix} ) \qquad ( 3 )$$

Equation (3) may then differentiated twice with respect to time to provide the following relationship:

\overline{\ddot{r}}=\dot{ω}₁²r₁[î(−cos ω₁t)+\hat{j}(−sin ωₜ)]+(ω₁+ω₂)²r₂[î(−cos(ω₁+ω₂)t)+\hat{j}(−sin(ω₁+ω₂)t)]+(ω₁+ω₂)²r₃[î(−cos(ω₁+ω₂)t+θ₃)+\hat{j}(−sin(ω₁+ω₂)t+θ₃)] (4)

We may determine the normal component of the acceleration of a point on the well wall or rod surface by the following relationships:

$$\begin{matrix}\frac{\ddot{\overline{r}} \cdot \overline{{r}_{3}}}{{r}_{3}} = {a}_{N} \\ or & ( 5 ) \\ {a}_{N} = - {ω}_{1}^{2} {r}_{1} cos ( {ω}_{2} t + {θ}_{3} ) - {( {ω}_{1} + {ω}_{2} )}^{2} ( {r}_{2} cos {ω}_{2} t + {r}_{3} ) & ( 6 )\end{matrix}$$

To determine the point at which this acceleration is maximum, the equations may be differentiated with respect to θ₃ and the result set equal to zero, the condition for which the normal component of the acceleration is maximal or minimal:

$$\frac{\partial {a}_{N}}{\partial {θ}_{3}} = {ω}_{1}^{2} {r}_{1} sin ( {ω}_{2} t + {θ}_{3} ) + {( {ω}_{1} + {ω}_{2} )}^{2} {r}_{2} sin {θ}_{3} = 0 \qquad ( 7 )$$

Solving Equation (7) for θ₃ provides the angle at which the normal acceleration is maximum at time t:

$${θ}_{3} = arctan ( \frac{- sin {ω}_{2} t}{α + cos {ω}_{2} t} ) \\ where α = {( 1 + \frac{{ω}_{2}}{{ω}_{1}} )}^{2} \frac{{r}_{2}}{{r}_{1}} . \qquad ( 8 )$$

It should be noted that Equation (8) also provides the angle at which acceleration is minimal, e.g., 180 degrees away from the point of maximum acceleration.

The angular rotation rate of the wall-spindle contact point of Equation (8) may be differentiated with respect to time to provide the following relationship:

$${\dot{θ}}_{3} = - {ω}_{2} \frac{1 + a cos {ω}_{2} t}{{sin}^{2} {ω}_{2} t + {( α + cos {ω}_{2} t )}^{2}} = {ω}_{3} \qquad ( 9 )$$

To determine the conditions under which the spindle will roll along the edge of the well without slipping, it may be necessary to consider the torque exerted on the spindle, as well as its respective moment of inertia. The driving torque on the spindle is caused by the tangential component of the acceleration vector. Computing the tangential acceleration at the contact point, it may be seen that, when the spindle is not slipping, this would also be the tangential acceleration of the spindle wall at the contact point. Assuming that the moment of inertia for the spindle is the same as that of a solid cylinder, the driving torque may be represented by the following relationship:

$${τ}_{4 d} = \frac{( {r}_{3} - {r}_{4} ) {m}_{4}}{2} {ω}_{1}^{2} α {r}_{2} ( \frac{{r}_{1}}{{r}_{2}} - 1 ) \frac{sin {ω}_{2} t}{{[ 1 + α + 2 α cos {ω}_{2} t ]}^{1 / 2}} \qquad ( 10 )$$

A second torque exerted on the spindle due to the friction between the spindle and floor of the spindle well may also exist and may be represented by the following relationship:

$${τ}_{4 f} = - \frac{2}{3} {μ}_{fs} {m}_{4} g {r}_{4} \qquad ( 11 )$$

The torque due to the friction between the spindle and the floor generally acts in the opposite direction from the driving torque. If the driving torque is not large enough to overcome the torque due friction, the spindle will not move. One exemplary method of operation for embodiments of the present subject matter is for the spindle to remain in contact with the wall of the spindle well without slipping. If the driving torque becomes so large that the driving torque is greater than the torque due to friction between the well wall and the spindle, the spindle will begin to slip. The condition under which the spindle will not slip may be represented by the following relationship:

$$- μ {m}_{4} [ \begin{matrix}{ω}_{1}^{2} {r}_{1} ( \frac{1 + α cos {ω}_{2} t}{{( {sin}^{2} {ω}_{2} t + {( α + cos {ω}_{2} t )}^{2} )}^{1 / 2}} ) + \\ {( {ω}_{1} + {ω}_{2} )}^{2} ( \frac{{r}_{2} ( α + cos {ω}_{2} t )}{{( {sin}^{2} {ω}_{2} t + {( α + cos {ω}_{2} t )}^{2} )}^{1 / 2}} ) + {r}_{3}\end{matrix} ] > \frac{{I}_{4}}{{r}_{4}^{2}} \frac{{( {ω}_{1} + {ω}_{2} )}^{2} ( {r}_{1} - {r}_{2} ) sin {ω}_{2} t}{{sin}^{2} {ω}_{2} t + {( α + cos {ω}_{2} t )}^{2}} \qquad ( 12 )$$

It is readily apparent to one skilled in the art that this derivation of the contact point is an idealized case ignoring both friction and the inertia of the spindle. In certain embodiments, the contact point between the spindle and the wall may lag slightly behind the theoretical contact point. The amount of this lag may be determined by the tangential component of the acceleration of the well wall. The spindle may deviate from the theoretical contact point in the direction of increasing tangential acceleration until the acceleration is great enough to overcome the effects of friction and the inertia of the spindle. It should also be noted that the larger the driving force is relative to the inertial drag and friction, the closer the contact point will be to the idealized case. Experimental data can easily be obtained taking both of these parameters into account.

A detailed study of the above equations illustrates that there are several different regimes in which exemplary deposition systems or apparatuses may operate, each being determined by a combination of various factors. Several of these factors will be examined and the ways in which they affect system performance detailed below. It should be noted that neither the list of factors, nor the operating regimes discussed are all inclusive or exclusive, and such examples should not limit the scope of the claims appended herewith.

For example, when exemplary tooling is operating, driving torque may be exerted on the spindle due to the tangential component of the wall's acceleration (see Equation (10)). There may also be a frictional force between the wall and the spindle. The spindle will generally rotate about its own axis as long as the driving torque is less than the maximum torque that can be supplied by static friction. Once the driving torque exceeds this force, the spindle may begin to slip (see Equation (12)). If this maximum allowable torque is exceeded, the contact point moves away from the point of maximum normal acceleration. However, there is still an applied torque, with the magnitude determined by the sliding coefficient of friction. Once the driving torque decreases to an extent, the spindle will stop slipping and move back towards the point determined by the maximum normal acceleration.

A second frictional force may exist between the bottom of the spindle and the floor of the well. This source of friction may exert a torque in the opposite direction of the driving torque. If the driving torque is not greater than this second frictional torque, the spindle will not move. For the tooling to operate efficiently, the coefficients of friction (both static and kinetic) between the bottom of the spindle and well floor should be as low as possible. These operating conditions may be summarized as: Torque from floor friction (A)<τ_{4d} (B)<slip inducing torque from wall friction (C). In detail, these operating conditions may be represented by the following relationships:

$$\begin{matrix}A = - \frac{2}{3} {μ}_{fs} {m}_{4} g {r}_{4} & ( 13 ) \\ B = \frac{{I}_{4}}{{r}_{4}} \frac{{r}_{1}}{{r}_{2}} ( {r}_{1} - {r}_{2} ) α {ω}_{1}^{2} \frac{sin {ω}_{2} t}{{sin}^{2} {ω}_{2} t + {( α + cos {ω}_{2} t )}^{2}} & ( 14 ) \\ C = {μ}_{ws} {r}_{4} [ {m}_{4} {r}_{1} {{ω}_{1}^{2} ( {sin}_{2} {ω}_{2} t + {( α + cos {ω}_{2} t )}^{2} )}^{1 / 2} + α \frac{{r}_{3}}{{r}_{2}} ] & ( 15 )\end{matrix}$$

where I₄ for solid cylinder is represented as I₄=m₄(r₄)²/2.

If rotation has not started, or if ω₄ changes sign, the coefficient of static friction governs the start of rotation. In the case where τ_{4d} is great enough for the spindle to “break loose,” a transient may occur. To summarize, the preferred mode of operation is when τ_{4d}/τ_{4f}>>1.

To maximize the frictional force between the well wall and the spindle there are multiple options available. Abrading or knurling the spindle surface to increase the coefficient of friction is an option for embodiments of the present subject matter. Selecting materials having high coefficients of friction for the spindle sides and well wall is another option for embodiments of the present subject matter. It should be noted, however, that the coefficient of friction of interest in these cases is the static coefficient, rather than the kinetic coefficient, as the spindle is rolling along the wall. If the spindle is slipping along the wall rather than rolling, the kinetic coefficient of friction becomes relevant. Similarly, the friction between the spindle and the well floor may be minimized through the appropriate choice of materials. Typically, tooling is constructed from materials such as aluminum and stainless steel, but many other materials are available such as copper, plastics, and so forth and such examples should not limit the scope of the claims appended herewith.

In the above discussion, the spindle was assumed to be a solid cylinder. It is easily seen that spindles of different shapes and weights may be utilized in embodiments of the present subject matter, and the equations for moments of inertia and torque may be adjusted accordingly. Therefore, any number of spindle weights, shapes, and materials may be utilized to obtain appropriate coefficients of friction or other values in embodiments of the present subject matter, and the examples provided herein should not limit the scope of the claims appended herewith.

For several of the system variables, there may be cases that consider another value, α, represented by the following relationship:

$$α = {( 1 + \frac{{ω}_{2}}{{ω}_{1}} )}^{2} \frac{{r}_{2}}{{r}_{1}} \qquad ( 16 )$$

The operating region in which α=0 results in a smooth rotation of the spindle at a constant ω₃. For α to equal zero, one of two conditions must generally be met: ω₂=−ω₁ or r₂=0. In this case, α is independent of either r₁ or r₂. For values of α<<1, the spindle will rotate at a rate that is very nearly constant. Thus, when α<1, then dθ₃/dt generally has the same sign, and the spindle rotates in one direction at varying rates. If α>1, then dθ₃/dt will vary between positive and negative and the movement of the contact point changes direction, rotating alternately clockwise and counterclockwise with no net rotation. If α is very large, rotation of the spindle approaches zero.

It follows that setting r₂=0 results in a distinct tooling configuration that may be useful. In such an embodiment of tooling, the spindle well would be centered in the middle of the planet rather than being at the edge. Such tooling would not be capable of holding more than one spindle, yet this would allow for a spindle well up to several inches in diameter, allowing the coating of large or unusually shaped substrates.

When α is close, or equal, to 1, another case of interest occurs. For example, when the value of α is near one, mathematical analysis shows that the spindle should undergo a large and rapid acceleration and deceleration. Experiments show that for this to happen the driving torque is so large that it overcomes the frictional force between the spindle and the well wall, and the spindle slips, resulting in an irregular rough motion. For the spindle to rotate smoothly, it follows that appropriate machine or apparatus parameters should be selected to ensure that α is not in this range.

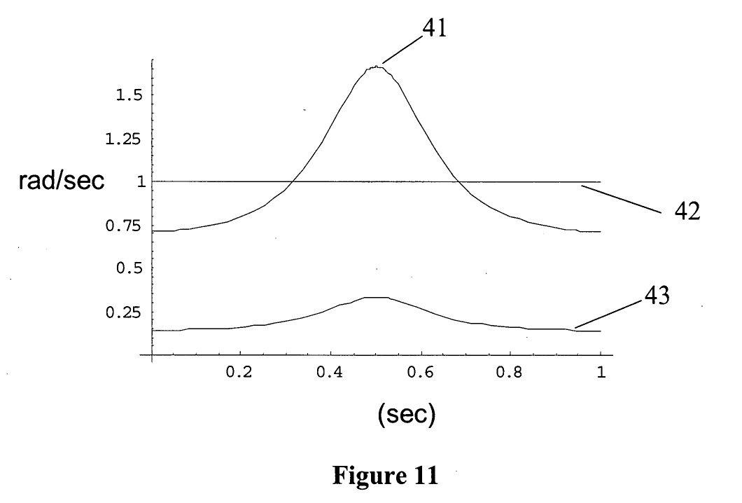

FIG. 11 is a graphical representation of rotation rates of embodiments of the present subject matter. With reference to FIG. 11, the rotation rate of a planet 42, the rotation rate of an arbitrary point on the well wall 41, and the rotation rate of a substrate 43 are graphically illustrated over a time period of one second for an alpha of 0.4 and a planet rotation rate of 60 rpm. The y-axis denotes the rotation rate in rad/sec, while the x-axis designates time in seconds. The flat line represents the constant rotation rate of the planet, while the larger curve 41 illustrates f₃. As expected, the point on the wall begins with a rotation rate smaller than that of the planet, gradually speeding up until peaking at a value higher than the planetary rotation rate, and then slowing back down. The smaller 43 of the two curves represents f₄, which corresponds to f₃ times a geometrical factor determined by machine configuration.

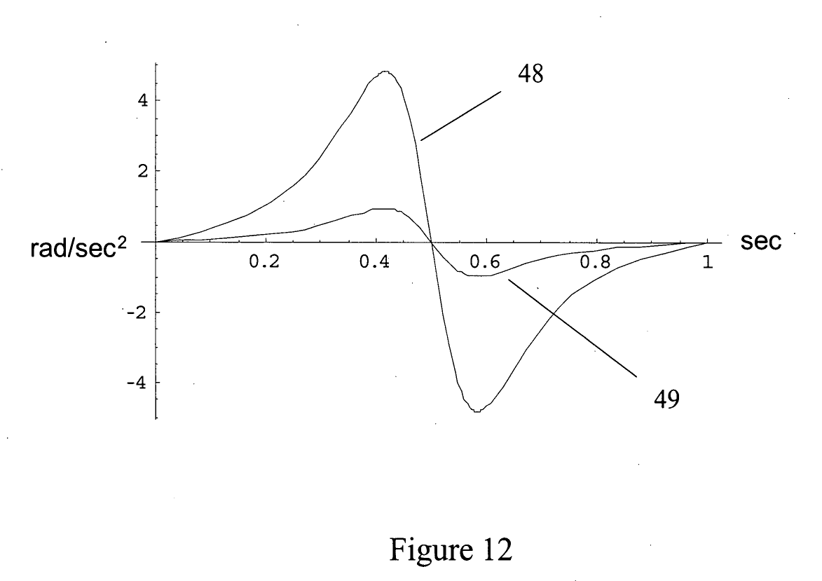

FIG. 12 is a graphical representation of angular accelerations of embodiments of the present subject matter. With reference to FIG. 12, derivatives of the curves depicted in FIG. 11 are provided. α is again 0.4 and the planet rotation is 60 rpm. The y-axis designates angular acceleration in radians/sec², while the x-axis designates the time. The larger curve 48 illustrates how the angular acceleration of a point on the wall increases and then decreases over time. The smaller curve 49 represents the angular acceleration of the rotating substrate.

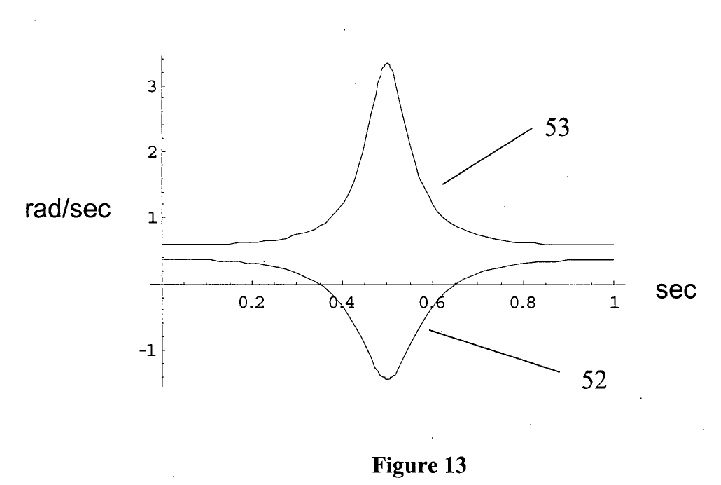

FIG. 13 is a graphical representation of rotation rates of embodiments of the present subject matter. With reference to FIG. 13, the rotation rate f₃ for a planet rotation speed of one rotation per second and α values of 1.7 and 0.7 are graphically illustrated. The y-axis designates the rotation rate in radians/sec and the x-axis denotes time. The first curve 52 descending below the x-axis represents the rotation for an a value of 1.7 and, as an examination of the area above and below the axis shows, there is no net rotation of the part. This is in accordance with experimental evidence in which the spindle rocks back and forth in the well but makes no net advance along the well wall. The second curve 53 represents the rotation for an α value of 0.7.

Conventional tooling rotates substrates at approximately 1000 rpm to ensure that each substrate undergoes at least one full rotation as the substrate passes in front of a target or through an oxidation zone. Table 1 below provides measured θ₄ values for varying α values. With reference to the values in Table 1, exemplary tooling according to embodiments of the present subject matter may provide a slower rate of rotation and selecting the system parameters to ensure the correct phasing of the substrates is important. The relevant parameters should be selected properly to ensure that a substrate is not facing the same way every time the substrate passes in front of the target resulting in a non-uniform coating. Table 1 also provides the observed rotation rates for a spindle in the well, a large open-ended tube placed on a fixed rod, and a small open-ended tube placed on a fixed rod, for several values of α and various drum and planet rotation rates. Tables 2-4 provide a more detailed examination of the data in Table 1, analyzing each rotating substrate in turn and comparing theoretical rotation rates to those observed in practice.

TABLE 1
Table of measured θ₄ values for varying α (frequencies are in rpm rather
than rps for clarity). Values for the below table: Spindle well diameter -
17.3 mm; Disc spindle diameter - 15.8 mm; Large rod diameter - 11.97 mm;
Small rod diameter - 6.5 mm; Glass tube inner diameter - 14.9 mm.

| Drum | Planet | | # spindle | # large rod | | # small rod | |
|---|---|---|---|---|---|---|---|
| speed (f1 | speed (f2 | | rotations | rotations (per | | rotations (per | |
| (rpm)) | (rpm)) | alpha | (per min) | min) | | min) | |
| 55 | −58.9 | 0.00 | 4.2 | 8.7 | (smooth) | 30.2 | (smooth) |
| 55 | −26.3 | 0.004 | 1.8 | 3.6 | (smooth) | 12.9 | (smooth) |
| 30 | 11.7 | 0.29 | 0.5 | Not moving | | 3.4 | |
| 55 | 35 | 0.4 | 2.3 | 4.7 | (smooth) | 17.5 | (smooth) |
| 50 | 46.7 | 0.57 | 2.8 | 5.6 | (smooth) | 21. | (smooth) |
| 55 | 55.4 | 0.61 | 3.6 | 7.3 | (smooth) | 24.9 | (smooth) |
| 35 | 40.8 | 0.71 | 1.0 | Rocking, does | | 4.1 | (not smooth) |
| | | | | not rotate | | | |
| 45 | 58 | 0.8 | 1.8 | 1.2 | (not smooth) | 7.5 | (not smooth) |
| 50 | 69.9 | 0.87 | 1.5 | 0.1 | (jerky) | 4.2 | (not smooth) |
| 60 | 93.2 | 0.99 | 1.5 | 0 | (rocks) | 4.7 | (not smooth) |

| | | | | | | |
|---|---|---|---|---|---|---|
| 40 | 70 | 1.14 | 0.5 | Rocking, does | 3.8 | (not smooth) |
| | | | | not rotate | | |

TABLE 2
Comparison of the experimental rotation rate of the
spindle to the theoretical rotation rate of the spindle
for various values of α.

| | | | | # spindle | Ratio |
|---|---|---|---|---|---|
| Drum | Planet | | # spindle | rotations- | of |
| speed (f1 | speed (f2 | | rotations- | experimental | theory |
| (rpm)) | (rpm)) | alpha | theory (rpm) | (rpm) | to exp. |
| 55 | −58.9 | 0.00 | 5.3 | 4.2 | 1.3 |
| 55 | −26.3 | 0.004 | 2.4 | 1.8 | 1.4 |
| 30 | 11.7 | 0.29 | 1.1 | 0.5 | 2.2 |
| 55 | 35 | 0.4 | 3.2 | 2.3 | 1.3 |
| 50 | 46.7 | 0.57 | 4.2 | 2.8 | 1.5 |
| 55 | 55.4 | 0.61 | 5.0 | 3.6 | 1.4 |
| 35 | 40.8 | 0.71 | 3.7 | 1.0 | 3.8 |
| 45 | 58 | 0.8 | 5.2 | 1.8 | 2.8 |
| 50 | 69.9 | 0.87 | 6.3 | 1.5 | 4.2 |
| 60 | 93.2 | 0.99 | 8.4 | 1.5 | 5.6 |
| 40 | 70 | 1.14 | 0 | 0.5 | 0 |

TABLE 3
Comparison of the experimental rotation rate of
the large rod to the theoretical rotation rate
of the large rod for various values of α.

| | | | | | | Ratio |
|---|---|---|---|---|---|---|
| Drum | Planet | | # large rod | # large rod- | | of |
| speed (f1 | speed (f2 | | rotations- | experimental | | theory |
| (rpm)) | (rpm)) | alpha | theory (rpm) | (rpm) | | to exp. |
| 55 | −58.9 | 0.00 | 11.8 | 8.7 | (smooth) | 1.4 |
| 55 | −26.3 | 0.004 | 5.6 | 3.6 | (smooth) | 1.6 |
| 30 | 11.7 | 0.29 | N/A | Not moving | | N/A |
| 55 | 35 | 0.4 | 7.0 | 4.7 | (smooth) | 1.5 |
| 50 | 46.7 | 0.57 | 9.3 | 5.6 | (smooth) | 1.6 |
| 55 | 55.4 | 0.61 | 11.1 | 7.3 | (smooth) | 1.5 |
| 35 | 40.8 | 0.71 | N/A | Rocking, does | | N/A |
| | | | | not rotate | | |
| 45 | 58 | 0.8 | 11.6 | 1.2 | (not smooth) | 10 |
| 50 | 69.9 | 0.87 | 14.0 | 0.1 | (jerky) | 144 |
| 60 | 93.2 | 0.99 | 0 | 0 | (rocks) | 0 |

| | | | | | |
|---|---|---|---|---|---|
| 40 | 70 | 1.14 | 0 | Rocking, does | 0 |
| | | | | not rotate | |

TABLE 4
Comparison of the experimental rotation rate of
the small rod to the theoretical rotation rate
of the small rod for various values of α.

| Drum | Planet | | # small rod | | | Ratio |
|---|---|---|---|---|---|---|
| speed | speed | | rotations- | # small rod- | | of |
| (f1 | (f2 | | theory | experimental | | theory |
| (rpm)) | (rpm)) | alpha | (rpm) | (rpm) | | to exp. |
| 55 | −58.9 | 0.00 | 33.0 | 30.2 | (smooth) | 1.1 |
| 55 | −26.3 | 0.004 | 14.7 | 12.9 | (smooth) | 1.1 |
| 30 | 11.7 | 0.29 | 6.6 | 3.4 | | 1.9 |
| 55 | 35 | 0.4 | 19.6 | 17.5 | (smooth) | 1.1 |
| 50 | 46.7 | 0.57 | 26.1 | 21. | (smooth) | 1.2 |
| 55 | 55.4 | 0.61 | 31.0 | 24.9 | (smooth) | 1.2 |
| 35 | 40.8 | 0.71 | 22.9 | 4.1 | not smooth) | 5.4 |
| 45 | 58 | 0.8 | 32.5 | 7.5 | (not smooth) | 4.2 |
| 50 | 69.9 | 0.87 | 39.1 | 4.2 | (not smooth) | 9.1 |
| 60 | 93.2 | 0.99 | 52.2 | 4.7 | (not smooth) | 11.1 |
| 40 | 70 | 1.14 | 0 | 3.8 | (not smooth) | 0 |

With reference to Tables 1-4 above, for values of α below 0.7, the ratio between the predicted rotation rate and the observed rotation rate is consistent within ten percent, well within experimental error. This indicates that a geometrical factor is present in the machine that can be determined by experiment. Upon determination of this factor, the rotation rate of parts may be accurately predicted. One exception occurs at an α value of 0.29 due to the low planetary rotation rate, which was slow enough not to provide sufficient centripetal force to rotate the tooling at the expected rate. For α values of one or greater, the theory predicts that the parts should not rotate, and the experimental evidence reflects this theory. For α values between 0.7 and 1, experimentation found that the motion of the tooling is no longer smooth and the experimental rotation rates are no longer in accordance with predicted rotation rates. This is consistent with the theory stating that the optimum region to operate is where α is less than or much less than one. Experiments have also shown that complex coatings of over forty layers and greater than four microns in thickness may be deposited on lamps with uniformity within one to two percent according to embodiments of the present subject matter. Each layer may require several passes past the target.

Several embodiments of the present subject matter may operate in conditions where the spindle stays in contact with the well wall without slipping. Another mode of operation for an embodiment may be the condition when the spindle is not in contact with the well wall at all times, but rather leaves contact with the wall at random intervals while rotating in one direction. The motion of the wall of the spindle well relative to the spindle is generally in one direction at any contact point, thus keeping the spindle rotating in one direction, although the rate of rotation is random. The same mathematical equations utilized to determine the conditions for which the spindle sticks to the wall may be utilized to determine the parameters for which this case applies (α is not a meaningful parameter in this case since the spindle is not in continuous contact with the wall).

A further mode of operation for an embodiment may be the condition where the spindle bounces off the wall of the spindle well at random and in varying directions, first rotating one way and then the other. The rate of rotation may also be random. Again, the mathematical equations mentioned in the previous cases can be used for determining when the case applies. It should be noted that while the mathematical analysis can predict when the spindle will leave the wall, it does not predict the motion of the spindle once this has occurred.

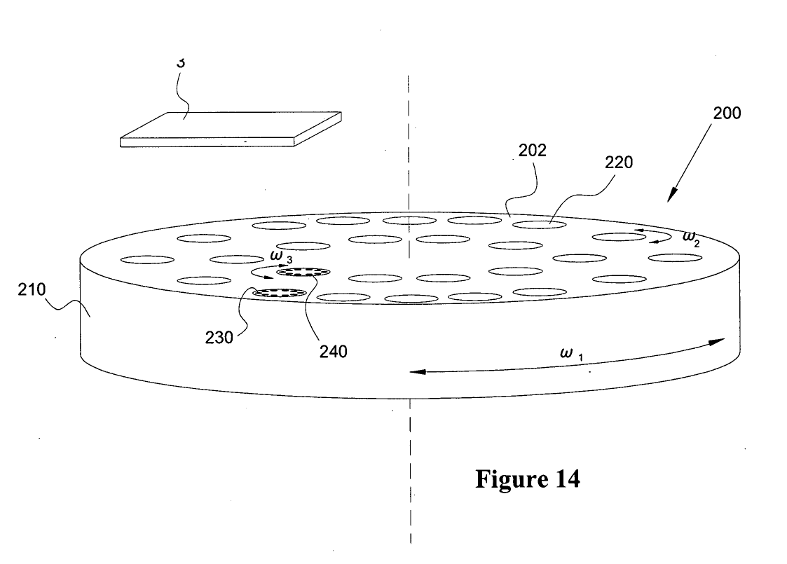

A further embodiment of the present subject matter may employ exemplary tooling in a disk coating machine. FIG. 14 is a perspective view of another embodiment of the present subject matter. With reference to FIG. 14, exemplary tooling may be employed in a disk coating machine 200. In such an embodiment, one or more planets 220 may be positioned about the periphery of the upper surface 202 of the disk 210. The disk 210 may be driven to rotate about its central axis at a rotational speed of ω₁ while each planet 220 is driven to rotate about its central axis at a rotational speed of ω₂. Each planet 220 may be driven to rotate at the same or different rotational speeds. The spindles 230 are positioned around the periphery of each planet 220 and rotate as described in the discussion of the drum configurations above. One or more interior rings of planets 240 may also be positioned on the upper surface 202 of the disk 210. Each planet in the interior ring of planets may be independently driven to rotate about its central axis at another rotational speed of ω₃. Of course, ω₃ may or may not be the same as ω₂. Similar to the peripheral ring of planets, each planet 240 may be driven to rotate at the same or different rotational speeds. Substrates (not shown) may be appropriately positioned in the respective spindles.

It is therefore an aspect of embodiments of the present subject matter to utilize the centripetal forces present in a rotating system to rotate substrates without the use of gears or bearings, thus alleviating the problems encountered in the prior art.

It is one aspect of embodiments of the present subject matter to provide novel tooling, significantly thinner than conventional racks and tooling, without gears or bearings to house to thereby greatly reduce shadowing and improve coating uniformity. In embodiments of the present subject matter where extreme precision is required in the coating, masking may be provided to deliberately shadow portions of the substrate according to a predetermined design.

It is also an aspect of embodiments of the present subject matter to select operating conditions for the tooling by selecting machine parameters for smooth and continuous motion of the spindle or rotating tubular substrate. Under the right conditions, the rotation of the substrates may be phased, which is important for even film distribution and oxidation. It is also an aspect of embodiments of the present subject matter to evenly coated substrates with complex multilayer coatings of over four microns in thickness. These coatings may be comprised of layers that require multiple passes past a target and may possess thickness variations of one to two percent.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. In a process of depositing a layer of material on an array of substrates in which the array is moved past one or more sources of deposition material in a first angular motion while concurrently being moved in a second angular motion, the improvement wherein each substrate moves in a third angular motion caused by the centripetal forces from the first and second angular motions.

2. The process of claim 1 wherein the first and second angular motions are in the same direction.

3. The process of claim 1 wherein the first and second angular motions are in opposite directions.

4. The process of claim 1 wherein the third angular motion varies in rate in one direction.

5. The process of claim 1 wherein the third angular motion varies in direction.

6. In a process of depositing a layer of material on an array of substrates in which the array is moved past one or more sources of deposition material in a first angular motion while concurrently being moved in a second angular motion, the improvement wherein the centripetal forces from the first and second angular motions cause each substrate to rotate about its axis.

7. A method of depositing material on an array of substrates comprising the steps of:
(a) moving the array of substrates past one or more sources of deposition material in a first rotational motion; and
(b) concurrently moving the array of substrates in a second rotational motion, wherein the combination of said first and second motions cause each of the substrates to move in a third rotational motion.

8. The method of claim 7 wherein the third rotational motion is the rotation of the substrate about its axis.

9. In a method of depositing a layer of material on an array of substrates, the method including the steps of:
(a) moving said substrates in a first motion past one or more sources of deposition material, said first motion comprising rotating a carrier about its longitudinal axis; while
(b) concurrently rotating each substrate about its longitudinal axis;
the improvement wherein each substrate is rotated about its longitudinal axis without gears and bearings.

10. In a method of depositing a layer of material on an array of substrates, the method including the steps of:
(a) moving said substrates in a first motion past one or more sources of deposition material, said first motion comprising rotating a carrier about its longitudinal axis; while
(b) concurrently rotating each substrate about its longitudinal axis;
the improvement wherein adjacent substrates rotate in the same direction about their longitudinal axes.

11. The method of claim 10 wherein all substrates in the array of substrates rotate in the same direction about their longitudinal axes.

12. A process for moving an array of substrates past one or more sources of deposition material comprising:
providing one or more pallets, each pallet comprising one or more axially aligned disks, each disk having a plurality of substrate holders positioned about the periphery thereof;
providing a pallet carrier;
positioning the pallets about the periphery of the pallet carrier;
positioning each substrate on a substrate holder;
driving the carrier to rotate about its central axis; and
driving the pallets to rotate each disk about its central axis,
wherein the forces exerted on the substrates as a result of driving the carrier and the pallets effect rotation of each substrate about its central axis.

13. The process of claim 12 wherein the pallets are driven in the same direction as the carrier.

14. The process of claim 12 wherein the pallets are driven in the opposite direction as the carrier.

15. The process of claim 12 wherein one or more spindles rotate in one direction.

16. The process of claim 12 wherein one or more spindles alternate rotation in the clockwise and counterclockwise directions.

17. The process of claim 12 wherein one or more substrate holders comprises a generally cylindrical spindle wherein each spindle is positioned in a spindle carrying well formed near the periphery of a disk, each well having a diameter larger than the diameter of the spindle positioned therein.

18. The process of claim 12 wherein one or more substrate holders comprises a rod positioned near the periphery of a disk.

19. An apparatus for moving an array of substrates in a thin film deposition process, said apparatus comprising:
a carrier having a generally circular cross-section and being rotatable about its central axis;
a carrier driving mechanism for rotating said carrier about its central axis;
a plurality of pallets, each pallet comprising a rotatable central shaft and one or more disks axially aligned along said central shaft, each disk comprising a plurality of spindle carrying wells positioned about the periphery of the disk, each well having a generally cylindrical wall;
a pallet driving mechanism for rotating the central shaft of each pallet to thereby rotate each disk about its central axis; and
a plurality of spindles each having a generally cylindrical wall, each spindle being adapted to be carried by a spindle carrying well so that the generally cylindrical wall of the spindle is adjacent the generally cylindrical wall of the spindle carrying well, each spindle being adapted to carry at least one substrate in axial alignment with the axis of the generally cylindrical wall of said spindle.

20. The apparatus of claim 19 wherein the centripetal forces resulting from the rotation of said carrier and a disk effects the rotation of the spindles positioned in the spindle wells of said disk.

21. The apparatus of claim 20 wherein said pallets are rotated in the same direction as said carrier.

22. The apparatus of claim 20 wherein said pallets are rotated in the opposite direction as said carrier.

23. The apparatus of claim 20 wherein said spindles rotate in one direction.

24. The apparatus of claim 20 wherein said spindles alternate rotation in the clockwise and counterclockwise directions.

25. The apparatus of claim 20 wherein said pallets each comprise at least two disks.

26. The apparatus of claim 20 wherein one or more of said disks comprise a peripheral ring forming a plurality of spindle carrying apertures, a central hub forming a central aperture around the central shaft of a pallet, and a plurality of spokes connecting the peripheral ring to the central hub.

27. The apparatus of claim 20 wherein the generally cylindrical walls of one or more spindles are knurled.

28. The apparatus of claim 20 wherein the generally cylindrical walls of one or more spindles has a material with a high coefficient of friction.

29. The apparatus of claim 20 wherein the generally cylindrical wall of one or more spindle carrying wells has a material with a high coefficient of friction.

30. An apparatus for moving an array of substrates in a thin film deposition process, said apparatus comprising:
a carrier having a generally circular cross-section and being rotatable about its central axis;
a carrier driving mechanism for rotating said carrier about its central axis;
a plurality of pallets, each pallet comprising a rotatable central shaft and one or more disks axially aligned along said central shaft, each disk comprising a plurality of substrate carrying rods positioned about the periphery of the disk, each rod being adapted to carry one or more substrates; and
a pallet driving mechanism for rotating the central shaft of each pallet to thereby rotate each disk about its central axis.

31. The apparatus of claim 30 wherein the centripetal forces resulting from the rotation of said carrier and a disk effects the rotation of one or more substrates carried by said substrate carrying rods on said disk.

32. An apparatus for carrying substrates in a thin film deposition system, said apparatus comprising:
a major carrier rotatable about a central axis;
one or more planetary disks carried by said major carrier and spaced from the central axis thereof, each planetary disk being rotatable about its central axis; and
a plurality of substrate holders positioned about the periphery of said planetary disks, each substrate holder being adapted to carry one or more substrates so that centripetal forces resulting from the rotation of said major carrier and said disks effects the rotation of each substrate carried by said disks about an axis of the substrate.

33. The apparatus of claim 32 wherein one or more of said substrate holders comprises a spindle having a generally cylindrical wall and a spindle carrying well formed in a planetary disk, said spindle carrying well having a generally cylindrical wall, said spindle being positioned in said well so that the generally cylindrical wall of said spindle in adjacent the generally cylindrical wall of said well, wherein said spindle is rotatable about its axis within said well by centripetal forces resulting from the rotation of said major carrier and said disk carrying said spindle.

34. The apparatus of claim 32 wherein one or more of said substrate holders comprises a rod extending upward from an upward facing surface of a planetary disk, said rod being adapted to hold one or more substrates, wherein the one or more substrates held by said rod are rotatable about said rod by centripetal forces resulting from the rotation of said major carrier and said disk carrying said rod.

35. A method of optimizing film distribution and oxidation of a layer of material on an array of substrates comprising moving the array of substrates past one or more sources of deposition material in a first angular motion having a first angular velocity while the array is concurrently being moved in a second angular motion having a second angular velocity, wherein the first and second angular velocities are substantially equal in magnitude and have opposite directions.

36. The method of claim 35 wherein the first angular motion is clockwise.

37. The method of claim 35 wherein the second angular motion is clockwise.

38. The method of claim 35 wherein the combination of the first and second motions cause each of the substrates to move in a third angular motion having a third angular velocity.

39. The method of claim 38 wherein each substrate is rotated about its longitudinal axis without gears and bearings.

40. The method of claim 38 wherein the third angular motion is substantially smooth and continuous.
